(19) United States
(12) Patent Application Publication
(10) Pub. No.: US 2020/0398519 A1
(43) Pub. Date: Dec. 24, 2020

(54) HONEYCOMB PANEL, MANUFACTURING METHOD THEREOF, AND HOUSING

(71) Applicant: SHINWA CONTROLS CO., LTD, Kawasaki-Shi (JP)

(72) Inventors: Kazushige TAKAHIRA, Kawasaki-Shi (JP); Shuya MATSUBAYASHI, Kawasaki-Shi (JP)

(73) Assignee: SHINWA CONTROLS CO., LTD, Kawasaki-Shi (JP)

(21) Appl. No.: 16/968,688

(22) PCT Filed: Mar. 1, 2019
(86) PCT No.: PCT/JP2019/008143

§ 371 Date: Aug. 10, 2020

(30) Foreign Application Priority Data
Mar. 5, 2018 (JP) 2018-038873

(51) Int. Cl. B32B 3/12; B32B 15/01; B32B 37/06; B21D 47/00

(52) U.S. Cl. CPC B32B 3/12; B32B 15/01; B23K 9/00; B21D 47/00; B32B 2605/00; B32B 37/06

(57) ABSTRACT

A honeycomb panel 1 includes: a honeycomb core 10 having a front surface 10A and a rear surface 10B; and a first plate member 11 provided on the front surface 10A of the honeycomb core 10; a first flange part 111 projecting inside a cell 10S is provided on an end edge of trapezoidal portions 101, 102 of one or more core strips 100 forming the honeycomb core 10, the end edge being positioned on the side of the first plate member 11. The first plate member 11 has one or more through-holes 121 overlapped with the first flange part 111, and is joined to the honeycomb core 10 by welding an outer surface of the first flange part 111, which faces outside through the through-hole 121, and an inner circumferential surface of the through-hole 121.

### FIELD OF THE INVENTION

The present invention relates to a honeycomb panel that can be used as a wall part of a structure for example, a manufacturing method thereof, and a housing comprising a honeycomb panel.

### BACKGROUND ART

A honeycomb panel comprising a core member (referred to as “honeycomb core” herebelow) formed by arraying or spreading a plurality of hexagonal cells, and a pair of plate members covering a front surface and a rear surface of the honeycomb core has been conventionally known.

For example, JP2544849B discloses a honeycomb panel made of metal such as stainless. In this honeycomb panel, a honeycomb core and plate members are integrated with each other by welding. The honeycomb core comprises a plurality of core strips formed by alternately arranging trapezoidal portions that project in directions reverse to each other. The plurality of core strips are disposed such that arrangement directions of the trapezoidal portions of the respective core strips are parallel to each other, and, between the adjacent core strips, tops of the trapezoidal portions projecting in the directions reverse to each other are opposed and joined to each other. Thus, a honeycomb pattern is formed on the honeycomb core.

In the honeycomb panel of JP2544849B, a flange part that bends inside the cell is provided on a top end edge of the trapezoidal portion that will face the plate member, and the flange part and the plate member are joined to each other by welding. The pair of plate members are sequentially joined to the honeycomb core. Namely, one of the plate members is joined to the flange part that faces the one plate member, and thereafter the other plate member is joined to the flange part that faces the other plate member, so that the joining operation of the honeycomb core and the pair of plate members is completed.

Two embodiments for joining the flange part and the plate members are described. Namely, in one embodiment, in a trapezoidal portion of one core strip and a trapezoidal portion of the other core strip, the adjacent core strips cooperatively forming cells, a flange part extends inside a cell from only a top end edge of one trapezoidal portion, and one flange part is welded to the plate member inside one cell. In addition, in the other embodiment, a flange part extends from each top end edge of both the trapezoidal portions, and two flange parts are welded to the plate member inside one cell.

When a first plate member (one of the aforementioned plate members) and the honeycomb core are welded to each other, no flange part is present on an end of the cell on an opposite side (the other side) of the first plate member. Alternatively, even if a flange part is present, an extension of the flange part is controlled so as not to inhibit passage of a laser beam for welding. Thus, in this technique, an operation for welding the honeycomb core and the plate member can be performed easily.

### SUMMARY OF THE INVENTION

In the honeycomb panel of the aforementioned JP2544849B, after the first plate member is joined to the honeycomb core by welding with a laser beam, the second plate is joined to the honeycomb core. At this time, after the second plate member is placed on the honeycomb core, the flange part and the plate member are welded to each other by applying a laser beam from above to the flange part through the plate member. In addition, a method in which a part of the plate member is brought up with respect to the honeycomb core and a laser beam is applied diagonally from above to the flange part and an inner surface of the plate member in contact with the flange part through a space between the flange part and the plate member is also disclosed.

However, in the method of applying a laser beam to the flange part through the plate member, it is necessary to apply a laser beam to the flange part under a condition where a position of the flange part cannot be visually observed, whereby it takes trouble to align them. In addition, in the method of applying a laser beam diagonally from above by bringing up a part of the plate member, a structure of the laser beam is complicated and it takes trouble to adjust an application position. Further, since the plate member must be made of a bendable material, freedom of material to be selected is limited.

In such a technique of JP2544849B, in order that welding conditions of a pair of plate members to the honeycomb are made uniform, it is considered that the same method for welding the honeycomb core and the respective plate members is used. However, in an actual application of the honeycomb panel, there exists a case in which a desired specification is satisfied even when welding conditions of plate members on both sides do not correspond to each other. In view of these circumstances, the present inventors have conducted extensive studies on the assumption that a honeycomb panel can be more efficiently manufactured without being bounded by a concept of making uniform welding conditions of a honeycomb core and respective plate members.

The present invention has been made in view of the above background. The object of the present invention is to provide a honeycomb panel in which a honeycomb core and plate members can be simply and securely joined to each other, a manufacturing method thereof, and a housing comprising such a honeycomb panel.

A honeycomb panel according to the present invention is a honeycomb panel comprising:

a honeycomb core having a front surface and a rear surface; and

a first plate member provided on the front surface of the honeycomb core;

wherein:

the honeycomb core has a plurality of core strips formed by alternately arranging trapezoidal portions that project in directions reverse to each other;

the respective core strips are disposed such that arrangement directions of the trapezoidal portions are parallel to each other, and that, between the adjacent core strips, tops of the trapezoidal portions projecting in the directions reverse to each other are opposed and joined to each other, so as to form a honeycomb pattern composed of a plurality of hexagonal cells that open to the front surface and the rear surface;

a first flange part projecting inside the cell is provided on an end edge of some or all of the trapezoidal portions of the one or more core strips, the end edge being positioned on the side of the first plate member;

the first plate member has one or more through-holes overlapped with the one or more first flange parts; and

the first plate member and the honeycomb core are joined to each other by welding, fusing or adhering an outer surface of the first flange part, which faces outside through the through-hole, and an inner circumferential surface of the through-hole.

The honeycomb core and the first plate member may be made of metal, the outer surface of the first flange part and the inner circumferential surface of the through-hole may be arc-welded to each other, and a welded metal portion may be provided between the outer surface of the first flange part and the inner circumferential surface of the through-hole.

The honeycomb panel according to the present invention may further comprise a second plate member provided on the rear surface of the honeycomb core, wherein:

a second flange part projecting inside the cell is provided on an end edge of some or all of the trapezoidal portions of the one or more core strips, the end edge being positioned on the side of the second plate member;

the second plate member has one or more surface-contact areas that are in surface contact with an outer surface of the one or more second flange parts, which faces the second plate member; and the second plate member and the honeycomb core are joined to each other by welding or fusing the outer surface of the second flange part and the surface-contact area.

The honeycomb core and the second plate member may be made of metal, and the outer surface of the second flange part and the surface-contact area may be spot-welded to each other.

The two second flange parts may be positioned inside at least some cells of the plurality of cells, and the second plate member may be joined to the two second flange parts inside some of the cells.

When the two second flange parts are positioned inside the one cell, the honeycomb core may be configured such that no first flange part is positioned inside this cell.

In addition, a manufacturing method of a honeycomb panel according to the present invention is a manufacturing method of a honeycomb panel comprising a honeycomb core having a front surface and a rear surface, and a first plate member provided on the front surface of the honeycomb core, wherein the honeycomb core has a plurality of core strips formed by alternately arranging trapezoidal portions that project in directions reverse to each other, and the respective core strips are disposed such that arrangement directions of the trapezoidal portions are parallel to each other, and that, between the adjacent core strips, tops of the trapezoidal portions projecting in the directions reverse to each other are opposed and joined to each other, so as to form a honeycomb pattern composed of a plurality of hexagonal cells that open to the front surface and the rear surface, the manufacturing method comprising the steps of:

preparing the honeycomb core provided with a first flange part projecting inside the cell on an end edge of some or all of the trapezoidal portions of the one or more core strips, the end edge being positioned on the side of the first plate member;

preparing the first plate member having one or more through-holes; and

positioning the first plate member with respect to the honeycomb core such that the through-hole is overlapped with the first flange part, and joining the first plate member and the honeycomb core by welding, fusing or adhering an outer surface of the first flange part, which faces outside through the through-hole, and an inner circumferential surface of the through-hole.

The honeycomb core and the first plate member may be made of metal, and the outer surface of the first flange part and the inner circumferential surface of the through-hole may be arc-welded to each other.

In addition, a housing according to the present invention is a housing comprising the aforementioned honeycomb panel as at least partially a wall part.

According to the present invention, the honeycomb core and the plate members can be simply and securely joined to each other.

### BRIEF DESCRIPTION OF THE DRAWINGS

FIG. 1 is a perspective view of a honeycomb panel according to a first embodiment of the present invention.

FIG. 2 is a sectional view of the honeycomb panel along a II-II line in FIG. 1.

FIG. 3 is a perspective view of a honeycomb core of the honeycomb panel shown in FIG. 1.

FIG. 4A is a view of the honeycomb core seen in a direction of an arrow IV in FIG. 3.

FIG. 4B is a view for describing a joint condition of a honeycomb core and a first plate member in the honeycomb panel shown in FIG. 1.

FIG. 4C is a sectional view of the honeycomb core and the first plate member along a C-C line in FIG. 4B.

FIG. 5 is a view for explaining an example of a manufacturing method of the honeycomb panel shown in FIG. 1.

FIG. 6 is a view for explaining the example of a manufacturing method of the honeycomb panel shown in FIG. 1.

FIG. 7 is a view for explaining the example of a manufacturing method of the honeycomb panel shown in FIG. 1.

FIG. 8 is a view for explaining the example of a manufacturing method of the honeycomb panel shown in FIG. 1.

FIG. 9 is a view for explaining the example of a manufacturing method of the honeycomb panel shown in FIG. 1.

FIG. 10 is a perspective view of a honeycomb core of a honeycomb panel according to a second embodiment of the present invention.

FIG. 11A is a view showing a housing in which the honeycomb panel according to each embodiment of the present invention can be installed.

FIG. 11B is a view showing a housing in which the honeycomb panel according to each embodiment of the present invention can be installed.

FIG. 11C is a view showing a housing in which the honeycomb panel according to each embodiment of the present invention can be installed.

### DETAILED DESCRIPTION OF THE INVENTION

Respective embodiments of the present invention will be described in detail below with reference to the attached drawings.

### First Embodiment

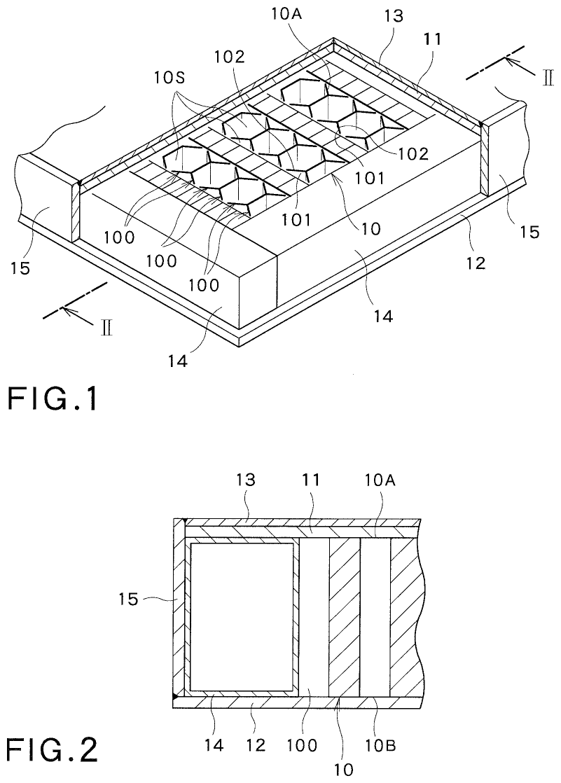

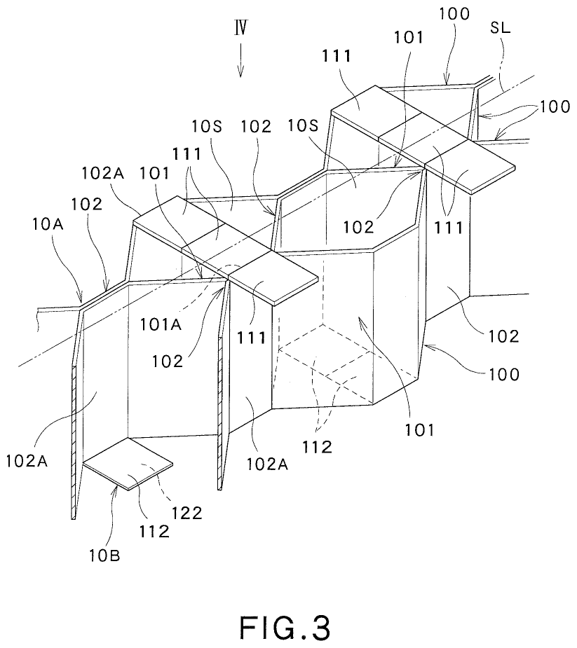

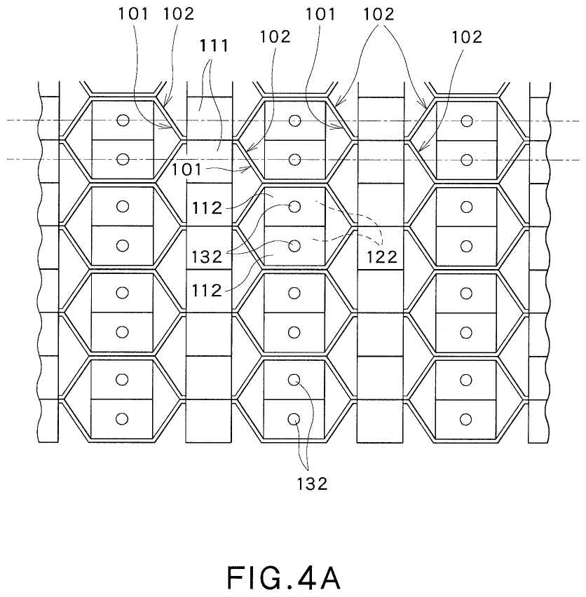

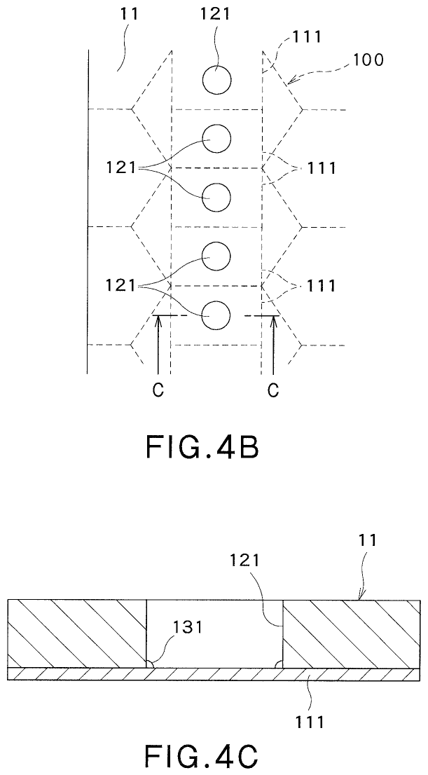

FIG. 1 is a perspective view of a honeycomb panel 1 according to a first embodiment. FIG. 2 is a sectional view of the honeycomb panel 1 along a II-II line in FIG. 1. FIG. 3 is a perspective view of a honeycomb core 10 of the honeycomb panel 1 shown in FIG. 1. FIG. 4A is a view of the honeycomb core 10 seen in a direction of an arrow IV in FIG. 3.

The honeycomb panel 1 according to this embodiment shown in FIGS. 1 and 2 comprises: a honeycomb core 10 having a front surface 10A and a rear surface 10B, a first plate member 11 provided on the front surface 10A of the honeycomb core 10, a second plate member 12 provided on the rear surface 10B, a third plate member 13 laid on a front surface of the first plate member 11, a frame member 14 that surrounds a side surface of the honeycomb core 10, which positioned between the front surface 10A and the rear surface 10B, and a side plate 15 surrounding the frame member 14.

The aforementioned respective constituent members constituting the honeycomb core 10 are formed of metal such as stainless or aluminum. However, these respective constituent members may be formed of resin. In addition, some of them may be formed of metal, and the rest may be formed of resin.

The honeycomb core 10 is a plate-like member that forms a honeycomb pattern by arraying or spreading a plurality of hexagonal cells 10S that open to both of the front surface 10A and the rear surface 10B. In this embodiment, the honeycomb core 10 has a rectangular profile. The honeycomb core 10 has a plurality of core strips 100. The core strip 100 is a band-like member formed by alternately arranging a first trapezoidal portion 101 and a second trapezoidal portion 102 that project in directions reverse to each other.

In FIG. 3 and FIG. 4A, a reference line SL showing a boundary between the first trapezoidal portion 101 and the second trapezoidal portion 102 is shown by two-dot chain lines. In this embodiment, a trapezoidal portion projecting downward in the sheet plane of FIG. 4A with respect to the reference line SL is defined as a first trapezoidal portion 101, and a trapezoidal portion projecting upward in the sheet plane of FIG. 4A with resect to the reference line SL is defend as a second trapezoidal portion 102.

The plurality of core strips 100 are disposed such that arrangement directions of the trapezoidal portions 101, 102 (directions along which the trapezoidal portions 101, 102 are arranged) are parallel to each other, and that, between the adjacent core strips 100, tops of the first trapezoidal portion 101 and the second trapezoidal portion 102 that project in the directions reverse to each other are opposed and joined to each other. Thus, the honeycomb core 10 forms a honeycomb pattern composed of a plurality of hexagonal cells 10S that open to the front surface 10A and the rear surface 10B.

In this embodiment, the tops of the first trapezoidal portion 101 and the second trapezoidal portion 102 are joined to each other by spot welding. However, they may be joined to each other by adhering. However, as compared with an adhesive agent, the spot welding can easily maintain a firmly joint condition of the first trapezoidal portion 101 and the second trapezoidal portion 102 under a high-temperature environment. Thus, in a case where the honeycomb panel is used in a high-temperature environment, spot welding is preferably employed.

In FIG. 3, the front surface 10A of the honeycomb core 10, which is to be covered with the first plate member 11, is seen from above. As shown in FIGS. 3 and 4A, first flange parts 111 projecting inside the cells 10S are provided on end edges of the first trapezoidal portion 101 and the second trapezoidal portion 102 of at least some of the core strips 100 of the plurality of core strips 100, the end edges being positioned on the side of the first plate member 11. In addition, second flange parts 112 projecting inside the cells 10S are provided on end edges of the first trapezoidal portion 101 and the second trapezoidal portion 102 of at least some of the core strips 100 of the plurality of core strips 100, the end edges being positioned on the side of the second plate member 12.

In this embodiment, each first flange part 111 is provided on an end edge of the top 101A of the first trapezoidal portion 101 or the top 102A of the second trapezoidal portion 102, the end edge being positioned on the side of the first plate member 11. In addition, each second flange part 112 is provided on an end edge of the top 101A of the first trapezoidal portion 101 or the top 102A of the second trapezoidal portion 102, the end edge being positioned on the side of the second plate member 12.

For some cells 10S, the plurality of first flanges parts 111 provided on the side of the first plate member 11 are formed such that the two first flange parts 111 are positioned inside one cell 10S. One of the two first flange parts 111 positioned inside one cell 10S is provided on an end edge of the first trapezoidal portion 101 of one core strip 100 forming the cells 10S in adjacent core strips 100, the end edge being positioned on the side of the first plate member 11. The other of the two first flange parts 111 is provided on an end edge of the second trapezoidal portion 102 of the other core strip 100 forming the cells 10S in the adjacent core strips 100, the end edge being positioned on the side of the first plate member 11.

Ends of the two first flange parts 111 positioned inside one cell 10S are in contact with each other in a direction perpendicular to the arrangement direction of the trapezoidal portions 101, 102. In addition, as shown in FIG. 4, when the two first flange parts 111 are positioned inside one cell 10S, the honeycomb core 10 is configured such that no second flange part 112 is positioned in this cell 10S.

On the other hand, for some cells 10S, the plurality of second flange parts 112 provided on the side of the second plate member 12 are formed such that the two second flange parts 112 are positioned inside one cell 10S. One of the two second flange parts 112 positioned inside one cell 10S is provided on an end edge of the second trapezoidal portion 102 of one core strip 100 forming the cells 10S in adjacent core strips 100, the end edge being positioned on the side of the second plate member 12. The other of the two second flange parts 112 is provided on an end edge of the second trapezoidal portion 102 of the other core strip forming the cells 10S in the adjacent core strips 100, the end edge being positioned on the side of the second plate member 12.

Similarly to the first flange parts 111, ends of the two second flange parts 112 positioned inside one cell 10S are in contact with each other in a direction perpendicular to the arrangement direction of the trapezoidal portions 101, 102. In addition, when the two second flange parts 112 are positioned inside one cell 10S on the side of the second plate member 12, the honeycomb core 10 is configured such that no first flange part 111 is positioned in this cell 10S on the side of the first plate member 11.

In addition, in this embodiment, on the honeycomb core 10, the two first flange parts 111 positioned inside one cell 10S are continuously (repeatedly) arrayed in a direction perpendicular to the arrangement direction of the trapezoidal portions 101, 102, and the two second flange parts 112 positioned inside one cell 10S are continuously (repeatedly) arrayed in a direction perpendicular to the arrangement direction of the trapezoidal portions 101, 102. The first flange parts 111 and the second flange parts 112 are formed such that a row in which the two first flange parts 111 inside one cell 10S are continuously arrayed in a direction perpendicular to the arrangement direction of the trapezoidal portions 101, 102, and a row in which the two second flange parts 112 inside one cell 10S are continuously arrayed in a direction perpendicular to the arrangement direction of the trapezoidal portions 101, 102 are alternately disposed in the arrangement direction, when seen in a plan view. Here, the plan view means that the core strips 100 are seen along a normal direction of the front/rear surface 10A, 10B of the plate like honeycomb core 10.

As described above, in order that a row in which the two first flange parts 111 inside one cell 10S are continuously arrayed in a direction perpendicular to the arrangement direction of the trapezoidal portions 101, 102, and a row in which the two second flange parts 112 inside one cell 10S are continuously arrayed in a direction perpendicular to the arrangement direction of the trapezoidal portions 101, 102 are alternately disposed when seen in a plan view, firstly, a core strip 100 of a first type in which the first flange parts 111 provided on end edges of the first trapezoidal portions 101 of the core strip 100, the end edges being positioned on the side of the first plate member 11, and the second flange parts 112 provided on end edges of the second trapezoidal portion 102 of the core strip 100, the end edges being positioned on the side of the second plate member 12, are alternately formed in the arrangement direction of the trapezoidal portions 101, 102 is needed. And a core strip 100 of a second type in which the second flange parts 112 provided on end edges of the first trapezoidal portions 101 of the core strip 100, the end edges being positioned on the side of the second plate member 12, and the first flange parts 111 provided on an end edge of the second trapezoidal portions 102 of the core strip 100, the end edges being positioned on the side of the first plate member 11 are alternately formed in the arrangement direction of the trapezoidal portions 101, 102 is needed.

In the two kinds of the core strips, when the core strip 100 of one type is inverted, the core strip 100 of the other type can be obtained. Such core strips 100 can be easily produced by a punching step and a step succeeding to the punching step, in which the flange parts 111, 112 are bent. Thicknesses of the two kinds of the core strips 100 may differ from each other. When the thickness of one core strip is ⅕ to ½ of the thickness of the other core strip, strain of the core strips 100 that may occur upon welding can be easily controlled.

The formation manner of the first flange parts 111 and the second flange parts 112 is not limited to the above manner. For example, the first flange parts 111 and the second flange parts 112 may be formed such that one or more first flange parts 11 may be positioned in one same cell 10S, and that one or more second flange parts 112 may be positioned in the same cell 10S.

Next, a joint condition of the first and second plate members 11, 12 and the honeycomb core 10 is described. The first plate member 11 is joined to the honeycomb core 10 through the first flange parts 111, and the second plate member 12 is joined to the honeycomb core 10 through the second flange parts 112. FIG. 4B is a view for describing the joint condition of the honeycomb core 10 and the first plate member 11 in the honeycomb panel 1, in which the first plate member 11 is seen along a direction normal to a plate plane of the first plate member 11. FIG. 4C is a sectional view of the honeycomb core 10 and the first plate member 11 along a C-C line in FIG. 4B.

As shown in FIG. 4B and FIG. 4C, the first plate member 11 has one or more (in this example, a plurality of) through-holes 121 overlapped with one or more (in this example, a plurality of) first flange parts 111. The first plate member 11 is joined to the honeycomb core 10 by welding an outer surface of the first flange part 111, which faces outside through the through-hole 121, and an inner circumferential surface of the through-hole 121. One through-hole 121 is provided per first flange part 111. Thus, inside one cell 10S, the first plate member 11 and the honeycomb core 10 are joined to each other at two points. The through-hole 121 has a circular shape, but may have another shape such as a rectangular shape.

In this embodiment, the outer surface of the first flange part 111 and the inner circumferential surface of the through-hole 121 are arc-welded. A welded metal portion 131 is provided between the outer surface of the first flange part 111 and the inner circumferential surface of the through-hole 121. Since the arc welding is performed by getting access to a boundary between the through-hole 121 and the first flange part 111 from outside the through-hole 121, the outer surface of the first flange part 111 and the inner circumferential surface of the through-hole 121 can be easily welded to each other. A type of the arc welding is not specifically limited, and various methods such as TIG welding, argon welding or the like can be employed. Welding between outer surface of the first flange part 111 and the inner circumferential surface of the through-hole 121 is not limited to the arc welding, and electrical resistance welding or brazing can be used.

In this embodiment, the outer surface of the first flange part 111 and the inner circumferential surface of the through-hole 121 are joined to each other by welding, but they may be joined to each other by adhesive bonding. In addition, when the first flange part 111 and the first plate member 11 are made of resin, they may be fused to each other by heating.

On the other hand, the second plate member 12 has a plurality of surface-contact areas 122 (see FIG. 3 and FIG. 4A) which are in surface contact with outer surfaces of the plurality of second flange parts 112, which face the second plate member 12. The second plate member 12 is joined to the honeycomb core 10 by welding the outer surface of the second flange part 112 and the surface-contact area 122 to each other. In this embodiment, since the two second flange parts 112 are positioned inside one cell 10S, the second plate member 12 and the honeycomb core 10 are joined to each other at two points inside one cell 10S. Herein, since the second plate member 12 is a plate member free of openings, air tightness to the honeycomb core 10 can be suitably ensured.

In this embodiment, the outer surfaces of the second flange parts 112 and the surface-contact areas 122 of the second plate member 12 are spot-welded to each other, so that the second plate member 12 is joined to the honeycomb core 10. In FIG. 4A, the reference numeral 132 shows a spot welding mark. As described in detail below, in this embodiment, the second plate member 12 is joined to the honeycomb core 10, prior to the first plate member 11. In a cell 10S inside which the two second flange parts 112 are positioned when the second plate member 12 and the rear surface 10B of the honeycomb core 10 are laid one on another, an opening portion on the side of the front surface 10A is not covered with the first flange part 111. Thus, since an electrode can be inserted into the cell 10S so as to easily bring the electrode into contact with the second flange part 112, the spot welding can be easily performed.

In this embodiment, the outer surface of the second flange part 112 and the surface-contact area 122 of the second plate member 12 are joined to each other by welding, but they may be joined to each other by means of adhering with an adhesive agent. In addition, when the second flange part 112 and the second plate member 12 are made of resin, they may be fused to each other by heating.

With reference again to FIGS. 1 and 2, the frame member 14 surrounds the side surface of the honeycomb core 10, and is positioned between the first plate member 11 and the second plate member 12. The frame member 14 is joined to the honeycomb core 10, the first plate member 11 and the second plate member 12 by welding. In addition, the side plate 15 surrounds a side surface of the frame member 14. In this embodiment, the second plate member 12 projects laterally outside from the frame member 14, and the side plate 15 is placed on the projecting portion. On the other hand, the first plate member 11 does not bulge from the frame member 14. The side plate 15 placed on the second plate member 12 projects from the frame member 14 and the first plate member 11. The side plate 15 is joined to the second plate member 12, the frame member 14 and the first plate member 11 by welding. The third plate member 13 covers the first plate member 11 by being fitted inside the side plate 15 projecting from the first plate member 11 and being welded to the side plate 15.

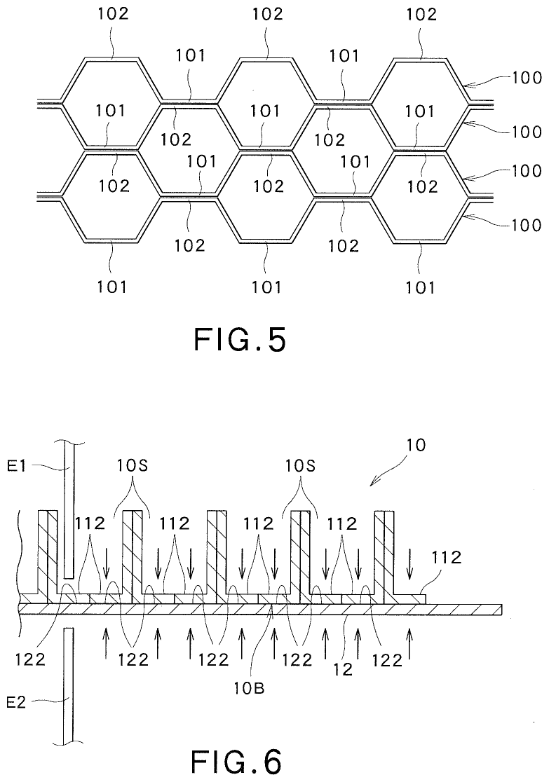

Next, an example of a manufacturing method of the honeycomb panel 1 according to this embodiment is described with reference to FIGS. 5 to 9. FIG. 5 is a view showing the core strip 100 seen along a direction normal to the front and rear surfaces 10A, 10B of the honeycomb core 10. FIGS. 6 to 9 are schematic sectional views in a case where a suitable position of the honeycomb core 10 is cut along a plane parallel to the direction normal to the front and rear surfaces 10A, 10B of the honeycomb core 10.

As shown in FIG. 5, a plurality of the core strips 100 are prepared. The respective core strips 100 are disposed such that the arrangement directions of the trapezoidal portions 101, 102 are parallel to each other. At this time, between the adjacent core strips 100, the tops of the first trapezoidal portions 101 and the second trapezoidal portions 102 projecting in the directions reverse to each other are opposed and are then joined to each other. In this embodiment, joining of the tops is performed by spot welding. Thus, the honeycomb core 10 forming a honeycomb pattern composed of a plurality of hexagonal cells that open to the front surface 10A and the rear surface 10B is formed.

Then, as shown in FIG. 6, the second plate member 12 and the rear surface 10B of the honeycomb core 10 are laid one on another, and they are joined to each other. In this embodiment, the second plate member 12 and the honeycomb core 10 are joined to each other by spot welding the outer surfaces of the second flange parts 112 and the surface-contact areas 122 of the second plate member 12.

Herein, in a cell 10S inside which the two second flange parts 112 are positioned, since the opening portion on the side of the front surface 10A is not covered with the first flange part 111, an electrode E1 can be inserted into the cell 10S so as to easily bring the electrode E1 into contact with the second flange part 112. Then, the second flange part 112 and the second plate member 12 are sandwiched between the electrode E1 and an electrode E2 located oppositely thereto, and electrical current is applied. Thus, the second plate member 12 and the honeycomb core 10 are joined to each other. In FIG. 6, points sandwiched between a pair of opposed arrows indicate spot welding positions.

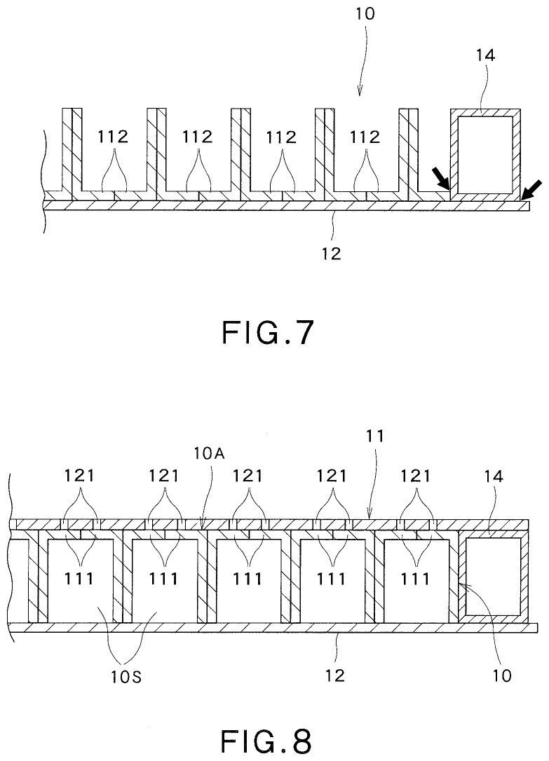

Then, as shown in FIG. 7, the frame member 14 is joined to the honeycomb core 10 and the second plate member 12 by welding. Arrows in FIG. 7 indicate positions at which the frame member 14 and its surrounding members are welded to each other. Herein, the frame member 14 and its surrounding members are welded by arc welding, but electrical resistance welding may be employed instead of arc welding.

Then, as shown in FIG. 8, the first plate member 11 and the front surface 10A of the honeycomb core 10 are laid one on another, and they are joined to each other. The first plate member 11 has a plurality of through-holes 121 overlapped with a plurality of first flanges 111, and is positioned with respect to the honeycomb core 10 such that the plurality of through-holes 121 are overlapped with the plurality of first flange parts 111 of the honeycomb core 10. Then, the first plate member 11 and the honeycomb core 10 are joined to each other by welding the outer surfaces of the first flange parts 111, which face outside through the through-hole 121, and the inner circumferential surfaces of the through-holes 121. In this embodiment, the outer surface of the first flange pat 111 and the inner circumferential surface of the through-hole 121 are arc-welded to each other. Since the arc welding is performed by getting access to a boundary between the through-hole 121 and the first flange part 11 from outside the through-hole 121, it can be easily performed.

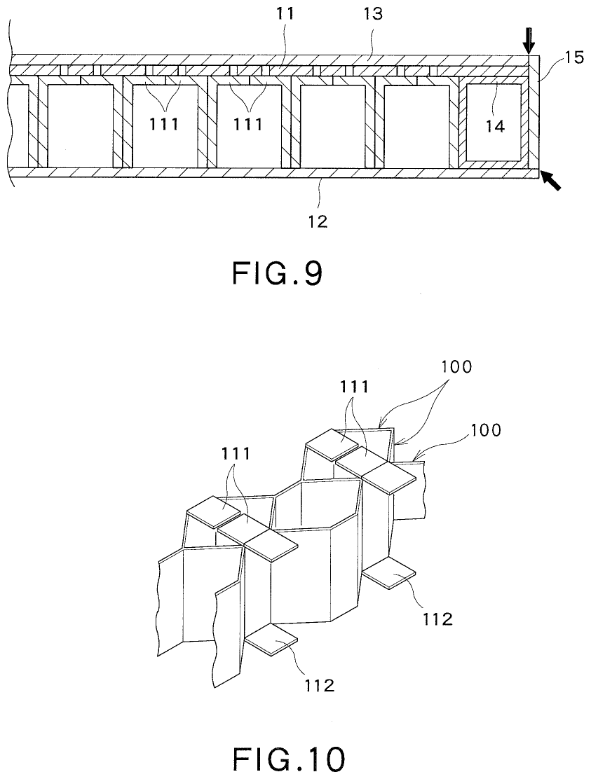

Thereafter, as shown in FIG. 9, the side plate 15 is joined to the circumference of the honeycomb core 10, and the third plate 13 is disposed on the first plate member 11 and is joined thereto. Arrows in FIG. 9 indicate positions at which the side plate 15 or the third plate member 13 and its surrounding members are welded to each other. Herein, the side plate 15 and the third plate member 13 and their surrounding members are welded by arc welding, but electrical resistance welding may be employed instead of arc welding.

In the honeycomb panel 1 according to the above-described embodiment, the first plate member 11 has a plurality of through-holes 121 overlapped with a plurality of first flange parts 111 provided on the honeycomb core 10, and the first plate member 11 and the honeycomb core 10 are joined to each other by welding the outer surface of the first flange part 111, which faces outside through the through-hole 121, and the inner circumferential surface of the through-hole 121. In this case, the outer surface of the first flange part 111 and the inner circumferential surface of the through-hole 121 can be welded while they are being visually confirmed. In addition, a large contact area between the outer surface of the first flange part 111 and the inner circumferential surface of the through-hole 121 can be ensured. Thus, the honeycomb core 10 and the first plate member 11 can be simply and securely joined to each other.

In addition, the outer surface of the first flange part 111 and the inner circumferential surface of the through-hole 121 are arc-welded, and the welded metal portion 131 is provided between the the outer surface of the first flange part 111 and the inner circumferential surface of the through-hole 121. Since the arc welding can be performed by getting access to a boundary between the through-hole 121 and the first flange part 11 from outside the through-hole 121, the outer surface of the first flange part 111 and the inner circumferential surface of the through-hole 121 can be easily and reliably welded to each other. In addition, the joint condition between the outer surface of the first flange part 111 and the inner circumferential surface of the through-hole 121 can be confirmed by observing the condition of the welded metal portion 131, for example. Thus, a reliable honeycomb panel 1 can be provided by performing repair according to need.

In addition, the second plate member 12 has a plurality of surface-contact areas 122 which are in surface contact with the outer surfaces of the plurality of second flange parts 112 provided on the honeycomb core 10, which face the second plate member 12. The second plate member 12 is joined to the honeycomb core 10 by welding the outer surface of the second flange part 112 and the surface-contact area 122. In this case, since the second plate member 12 is joined to the honeycomb core 10 without the through-hole 121 provided in the first plate member 11, air tightness to the honeycomb core 10 can be suitably ensured.

In addition, since the outer surface of the second flange part 112 and the surface-contact area 122 are spot-welded, generation of metallic oxide can be suppressed as compared with the arc welding, whereby generation of gas caused by such a metallic oxide can be suppressed. When the honeycomb panel 1 is used partially as a wall part of a housing an inside of which is hermetically sealed, generation of a gas caused by a metallic oxide is sometimes undesired. In this case, joining by spot welding is particularly useful.

In addition, in this embodiment, the two second flange parts 112 are positioned inside at least some of the cells 10S of a plurality of cells 10S in the honeycomb panel 1, and the second plate member 12 is joined to the two second flange parts 112 inside some of the cells 10S. In this case, since a contact area between the second plate member 12 and the second flange part 112 increases, joint strength can be improved.

In addition, when the two second flange parts 112 are positioned inside one cell 10S, the honeycomb core 10 is configured such that no first flange 111 is positioned inside this cell 10S. Thus, since a welding member such as an electrode E1 can be inserted into the cell 10S so as to easily bring the electrode E1 into contact with the second flange part 112, a manufacturing efficiency of the honeycomb panel 1 can be improved.

### Second Embodiment

Next, a second embodiment is described with reference to FIG. 10. Constituent members of the second embodiment, which are similar to the constituent members of the first embodiment, have the same reference numerals and their description is omitted.

In the first embodiment, when the two first flange parts 111 are positioned inside one cell 10S, ends of these two first flange parts 111 are in contact with each other. In addition, when the two second flange parts 112 are positioned inside one cell 10S, ends of these two second flange parts 112 are in contact with each other.

In place of this, in the second embodiment, as shown in FIG. 10, when the two first flange parts 111 are positioned inside one cell 10S, ends of these two first flange parts 111 are spaced apart from each other. In addition, when the two second flange parts 112 are positioned inside one cell 10S, ends of these two second flange parts 112 are spaced apart from each other. Such a structure is suitable for a case in which a honeycomb panel is used in an environment where the honeycomb panel is likely to be thermally deformed. Namely, in a situation where flange parts are thermally deformed to push each other so that an undesired stress is generated, the second embodiment is preferably employed. On the other hand, in the structure in which the ends of the flange parts are in contact with each other as in the first embodiment, since friction is generated in the contact areas of the flange parts when the joined plate members are to be separated from each other, such a structure is useful in a case where a holding force of the honeycomb panel with respect to the plate members is desired to be ensured.

<Housing in which Honeycomb Panel can be Installed>

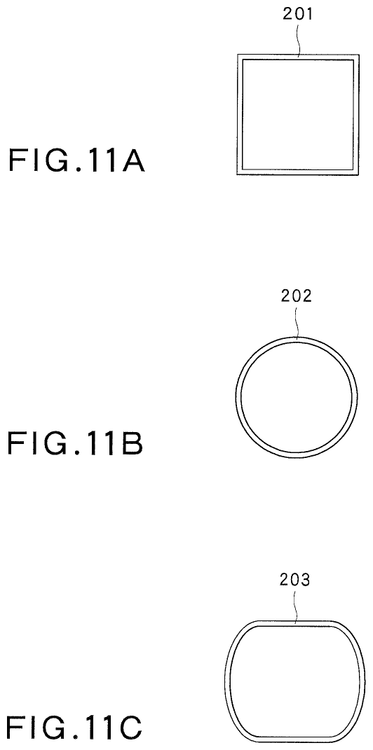

FIGS. 11A to 11C are views each showing a housing in which a honeycomb panel according to each embodiment of the present invention can be installed. The honeycomb panel according to each embodiment may be used in a housing 201 whose wall part has a rectangular cross-section as shown in FIG. 11A, a housing 202 whose wall part has a circular cross-section as shown in FIG. 11B, or a housing 203 whose wall part has a race track like cross-section having a pair of curved portions and a pair of straight portions as shown in FIG. 11C, and may at least partially constitute the wall part.

When each of the aforementioned housings 201 to 203 is a housing such as a vacuum deposition chamber an inside of which is heated up to a high temperature and vacuumed, it is recommendable to locate the honeycomb panel such that the second plate member faces inside and that the first plate member faces outside, so as to constitute the wall part of the housing. In this case, a suitable air tightness is maintained between the second plate member 12 and the honeycomb core 10, while a sufficient resistance force against vacuum suction can be ensured because the second plate member 12 is joined to the two second flange parts 112 per cell 10S, for example. On the other hand, although the first plate member 11 has the through-holes 121, the first plate member 11 is simply and securely joined to the honeycomb core. Thus, a specification required on a side that is not exposed to vacuum can be sufficiently satisfied, while the manufacturing efficiency of the honeycomb panel can be improved and the cost can be reduced. Thus, when the honeycomb panel according to the embodiments is applied to a housing, in addition to saving a weight, a specification desired for a housing is sufficiently satisfied, while a manufacturing efficiency of the housing can be improved as well as the cost can be reduced. Thus, various advantages can be obtained in the housing. A housing is not specifically limited. In addition, the honeycomb panel according to the embodiments can be used as a wall part of a train, an automobile, an aircraft, a rocket, a shelter and the like.

Although the respective embodiments of the present invention have been described above, the present invention is not limited to the aforementioned respective embodiments, and can be variously modified in the respective embodiments.

For example, in the aforementioned respective embodiments, the first flange part 111 and the second flange part 112 are provided on tops of the trapezoidal portions of the core strip 100. However, in place of this, the first flange part 111 or the second flange part 112 may be provided on both or one of a pair of sides of the trapezoidal portion.

### DESCRIPTION OF REFERENCE NUMERALS

1 Honeycomb panel
10 Honeycomb core
10A Front surface
10B Rear surface
10S Cell
11 First plate member
12 Second plate member
13 Third plate member
14 Frame member
15 Side plate
100 Core strip
101 First trapezoidal portion
101A Top
102 Second trapezoidal portion
102A Top
111 First flange part
112 Second flange part
121 Through-hole
122 Surface-contact area
131 Welded metal portion
201 to 203 Housing

1. A honeycomb panel comprising:
a honeycomb core having a front surface and a rear surface; and
a first plate member provided on the front surface of the honeycomb core;
wherein:
the honeycomb core has a plurality of core strips formed by alternately arranging trapezoidal portions that project in directions reverse to each other;
the respective core strips are disposed such that arrangement directions of the trapezoidal portions are parallel to each other, and that, between the adjacent core strips, tops of the trapezoidal portions projecting in the directions reverse to each other are opposed and joined to each other, so as to form a honeycomb pattern composed of a plurality of hexagonal cells that open to the front surface and the rear surface;
a first flange part projecting inside the cell is provided on an end edge of some or all of the trapezoidal portions of the one or more core strips, the end edge being positioned on the side of the first plate member;
the first plate member has one or more through-holes overlapped with the one or more first flange parts; and
the first plate member and the honeycomb core are joined to each other by welding, fusing or adhering an outer surface of the first flange part, which faces outside through the through-hole, and an inner circumferential surface of the through-hole.

2. The honeycomb panel according to claim 1, wherein
the honeycomb core and the first plate member are made of metal, the outer surface of the first flange part and the inner circumferential surface of the through-hole are arc-welded to each other, and a welded metal portion is provided between the outer surface of the first flange part and the inner circumferential surface of the through-hole.

3. The honeycomb panel according to claim 1, further comprising a second plate member provided on the rear surface of the honeycomb core, wherein:
a second flange part projecting inside the cell is provided on an end edge of some or all of the trapezoidal portions of the one or more core strips, the end edge being positioned on the side of the second plate member;
the second plate member has one or more surface-contact areas that are in surface contact with an outer surface of the one or more second flange parts, which faces the second plate member; and
the second plate member and the honeycomb core are joined to each other by welding or fusing the outer surface of the second flange part and the surface-contact area.

4. The honeycomb panel according to claim 3, wherein
the honeycomb core and the second plate member are made of metal, and the outer surface of the second flange part and the surface-contact area are spot-welded to each other.

5. The honeycomb panel according to claim 3, wherein:
the two second flange parts are positioned inside at least some cells of the plurality of cells; and
the second plate member is joined to the two second flange parts inside some of the cells.

6. The honeycomb panel according to claim 5, wherein
when the two second flange parts are positioned inside the one cell, the honeycomb core is configured such that no first flange part is positioned inside this cell.

7. A manufacturing method of a honeycomb panel comprising a honeycomb core having a front surface and a rear surface, and a first plate member provided on the front surface of the honeycomb core, wherein the honeycomb core has a plurality of core strips formed by alternately arranging trapezoidal portions that project in directions reverse to each other, and the respective core strips are disposed such that arrangement directions of the trapezoidal portions are parallel to each other, and that, between the adjacent core strips, tops of the trapezoidal portions projecting in the directions reverse to each other are opposed and joined to each other, so as to form a honeycomb pattern composed of a plurality of hexagonal cells that open to the front surface and the rear surface, the manufacturing method comprising the steps of:
preparing the honeycomb core provided with a first flange part projecting inside the cell on an end edge of some or all of the trapezoidal portions of the one or more core strips, the end edge being positioned on the side of the first plate member;
preparing the first plate member having one or more through-holes; and
positioning the first plate member with respect to the honeycomb core such that the through-hole is overlapped with the first flange part, and joining the first plate member and the honeycomb core by welding, fusing or adhering an outer surface of the first flange part, which faces outside through the through-hole, and an inner circumferential surface of the through-hole.

8. The manufacturing method of a honeycomb panel according to claim 7, wherein
the honeycomb core and the first plate member are made of metal, and the outer surface of the first flange part and the inner circumferential surface of the through-hole are arc-welded to each other.

9. A housing comprising the honeycomb panel according to claim 1 as at least partially a wall part.

10. The honeycomb panel according to claim 4, wherein:
the two second flange parts are positioned inside at least some cells of the plurality of cells; and
the second plate member is joined to the two second flange parts inside some of the cells.
